(19) United States
(12) Patent Application Publication
(10) Pub. No.: US 2007/0132402 A1
(43) Pub. Date: Jun. 14, 2007

(54) Lighting-drive device, light source device, and display device

(75) Inventors: Yoshimasa Kitta, Kanagawa (JP); Kenichi Kobayashi, Kanagawa (JP); Hitoshi Akiho, Miyagi (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/589,266

(22) Filed: Oct. 26, 2006

(30) Foreign Application Priority Data
Dec. 8, 2005 (JP) P2005-355122

(51) Int. Cl. H05B 41/36

(52) U.S. Cl. 315/291

(57) ABSTRACT

A lighting-drive device includes: a lighting-drive circuit configured to drive a lamp for lighting of the lamp; an activation circuit configured to produce an activation voltage to be applied to the lamp in order to start lighting of the lamp; and an activation operation detector configured to be provided with a sensing member for sensing an induced voltage and output an operation state notification signal depending on a state of the induced voltage. The sensing member is provided on a circuit substrate on which the activation circuit is formed in such a manner as to be allowed to sense the induced voltage. The activation current flows in response to the activation voltage produced by the activation circuit. The operation state notification signal indicates whether or not the activation circuit has operated normally. The lighting-drive circuit, the activation circuit and the activation operation detector are integrated into one single component.

### CROSS REFERENCES TO RELATED APPLICATIONS

The present invention contains subject matter related to Japanese Patent Application JP 2005-355122 filed with the Japanese Patent Office on Dec. 8, 2005, the entire contents of which being incorporated herein by reference.

### BACKGROUND OF THE INVENTION

1. Field of the Invention

The present invention relates to a lighting-drive device for driving a lamp such as a high intensity discharged (HID) lamp for the lighting thereof, and to a light source device and a display device that include such a lighting-drive device.

2. Description of the Related Art

An image display device such as a projector device includes a light source and modulates light emitted from the light source by a liquid crystal panel or the like based on video signals, so that the modulated light is projected on a screen in a magnified form and thus images are displayed.

As this light source, an HID lamp is widely employed. Drive circuitry for driving such a lamp for the lighting thereof can be regarded as a power supply device that supplies the lamp with power, and is referred to as a ballast power supply.

To initiate the lighting of the HID lamp, as is well known, a pulse high voltage (ignition pulse) on the order of kilovolts is applied to the lamp to induce a discharge inside the lamp. A circuit that produces and applies the high voltage pulse in order to start the lighting of the lamp is referred to as an ignition circuit, and this ignition circuit is also included in the ballast power supply.

Furthermore, in the configuration employing an HID lamp as its light source, ignition detection is implemented to detect whether or not the ignition circuit has operated normally at the time of the activation of the lamp.

For example, there would be a case where an HID lamp fails to be lit although a trigger for lighting the HID lamp has been supplied thereto. In this case, the cause of the failure of the lighting of the HID lamp is involved in at least one of the HID lamp itself and the ignition circuit.

In view of this, if it can be determined whether or not the ignition circuit has operated normally at the time of the initiation of the lighting of the HID lamp for example, it is easy to identify which of the ignition circuit and HID lamp involves the cause of the failure of the lighting of the HID lamp, which facilitates the response to a breakdown. For that reason, the function of the ignition detection is provided.

The ballast power supply is incorporated into a projector device as one component unit. The configuration for the ignition detection is provided with a coated conductive lead with a certain degree of length as an antenna line. This antenna line is disposed in such a manner as to be routed outside the component unit as the ballast power supply and near the position of the ignition circuit. In the thus disposed antenna line, a voltage is induced due to a current that flows in response to output of an ignition pulse from the ignition circuit. In the ignition detection, this induced voltage is sensed, which can determine whether or not the ignition circuit is normally operating.

An example of the related art of the present invention is disclosed in e.g. Japanese Patent Laid-open No. Hei 9-293595.

In the above-described ignition detection configuration, it is necessary that an antenna line extended to a certain degree of length be routed outside the component unit as the ballast power supply. The coated conductive lead as the antenna line is a member obtained by coating a properly thin conductive lead with resin or the like, and therefore is difficult to fix at the required position as it is. Accordingly, it is necessary to provide a mechanical holding component or the like for fixedly disposing the antenna line, which leads to a problem of corresponding increases in the component size and costs. Furthermore, this ignition detection configuration is to detect an ignition pulse by use of a mechanical structure in which merely the antenna line is disposed, and hence practically involves variation in the sensed value of the induced voltage due to misalignment of the antenna line and so on. Thus, it is difficult to equalize the sensitivity of the ignition detection among products in a favorable state. In addition, noise other than the inducted voltage in response to an ignition pulse is readily received. These problems make it difficult to design the circuit for the ignition detection, and deteriorate the reliability of the ignition detection, for example.

As described above, there is room for improvement in the present configuration for the ignition detection.

### SUMMARY OF THE INVENTION

In consideration of the above-described problems, according to an embodiment of the present invention, there is provided a lighting-drive device having the following configuration.

Specifically, the lighting-drive device includes a lighting-drive circuit, an activation circuit, and an activation operation detector. The lighting-drive circuit configured to drive a lamp for the lighting of the lamp. The activation circuit configured to produce an activation voltage to be applied to the lamp in order to start the lighting of the lamp. The activation operation detector configured to be provided with a sensing member for sensing an induced voltage arising due to an activation current and output an operation state notification signal depending on the state of the induced voltage sensed by the sensing member. The sensing member is provided on a circuit substrate on which the activation circuit is formed, in such a manner as to be allowed to sense the induced voltage. The activation current flows in response to the activation voltage produced by the activation circuit. The operation state notification signal indicates whether or not the activation circuit has operated normally. The lighting-drive circuit, the activation circuit and the activation operation detector are integrated into one single component.

According to another embodiment of the invention, there is provided a light source device having the following configuration.

Specifically, the light source device includes a lamp, a lighting-drive circuit, an activation circuit, and an activation operation detector. The lamp configured to serve as a light source. The lighting-drive circuit configured to drive the lamp for the lighting of the lamp. The activation circuit configured to produce an activation voltage to be applied to the lamp in order to start the lighting of the lamp. The activation operation detector configured to be provided with a sensing member for sensing an induced voltage arising due to an activation current and output an operation state notification signal depending on the state of the induced voltage sensed by the sensing member. The sensing member is provided on a circuit substrate on which the activation circuit is formed, in such a manner as to be allowed to sense the induced voltage. The activation current flows in response to the activation voltage produced by the activation circuit. The operation state notification signal indicates whether or not the activation circuit has operated normally. At least the lighting-drive circuit, the activation circuit, and the activation operation detector are integrated into one single component.

According to another embodiment of the invention, there is provided a display device having the following configuration.

Specifically, the display device includes a lamp, a lighting-drive device, and an image display unit. The lamp configured to serve as a light source. The lighting-drive device configured to drive the lamp for the lighting of the lamp. The image display unit configured to display an image by use of light emitted from the light source. The lighting-drive device includes a lighting-drive circuit, an activation circuit, and an activation operation detector. The lighting-drive circuit that drives the lamp for the lighting of the lamp. The activation circuit that produces an activation voltage to be applied to the lamp in order to start the lighting of the lamp. The activation operation detector that is provided with a sensing member for sensing an induced voltage arising due to an activation current and outputs an operation state notification signal depending on the state of the induced voltage sensed by the sensing member. The sensing member is provided on a circuit substrate on which the activation circuit is formed, in such a manner as to be allowed to sense the induced voltage. The activation current flows in response to the activation voltage produced by the activation circuit. The operation state notification signal indicates whether or not the activation circuit has operated normally. At least the lighting-drive circuit, the activation circuit, and the activation operation detector are integrated into one single component.

According to the above-described respective configurations, the part that includes the following elements is constructed as one single component unit integrally: the lighting-drive circuit for driving a discharge lamp for the (steady) lighting thereof, the activation circuit for starting the lighting of the discharge lamp, and the activation operation detector for detecting the normality of operation of the activation circuit. The active operation detector employs a configuration in which a sensing member senses an induced voltage arising due to an activation current flowing in response to an activation voltage. In embodiments of the invention, the activation circuit and the activation operation detector are housed in the same single component as described above. Thus, the sensing member can be easily disposed at such an appropriate position in the single component as to be capable of sensing an induced voltage.

As described above, according to embodiments of the invention, a sensing member can be provided in a single component together with an activation circuit. Therefore, there is no need to provide a member for fixing the sensing member around the component, which contributes to corresponding cost down, component size reduction, improved component mounting efficiency, and so on. In addition, the sensing member can be more strictly disposed at such a position as to be capable of sensing an induced voltage. Therefore, the detection sensitivity is stabilized and variation therein is eliminated. Furthermore, the anti-noise characteristic is improved. These advantages enhance the design efficiency and reliability of the device. Thus, embodiments of the invention allow a configuration for start of lighting to be improved in terms of various aspects.

### BRIEF DESCRIPTION OF THE DRAWINGS

FIG. 1 is a diagram showing a configuration example of a projector device that is a display device as an embodiment of the present invention;

FIGS. 2A and 2B are a timing chart showing an example of a lighting-drive system for a lamp;

FIG. 3 is a waveform diagram showing an ignition pulse applied to start the lighting of a lamp;

FIG. 4 is a waveform diagram showing an ignition pulse applied to start the lighting of a lamp;

FIG. 5 is a diagram showing a first configuration example for ignition detection of the embodiment;

FIG. 6 is a diagram showing an example of the way of disposing of a sensing member on a substrate, corresponding to the first configuration example for ignition detection of the embodiment;

FIG. 7 is a diagram showing a second configuration example for ignition detection of the embodiment;

FIG. 8 is a diagram showing an example of the way of disposing of a sensing member on a substrate, corresponding to the second configuration example for ignition detection of the embodiment;

FIG. 9 is a diagram showing a third configuration example for ignition detection of the embodiment;

FIG. 10 is a diagram showing a fourth configuration example for ignition detection of the embodiment;

FIG. 11 is a diagram showing an example of the way of disposing of a sensing member on a substrate, corresponding to the fourth configuration example for ignition detection of the embodiment;

FIG. 12 is a diagram showing a fifth configuration example for ignition detection of the embodiment;

FIG. 13 is a diagram showing an example of the way of disposing of a sensing member on a substrate, corresponding to the fifth configuration example for ignition detection of the embodiment;

FIG. 14 is a diagram showing an internal configuration example of a ballast power supply unit of the embodiment;

FIG. 15 is a circuit diagram showing an internal configuration example of an ignition detection circuit of the embodiment;

FIG. 16 is a diagram showing an existing configuration example for ignition detection;

FIG. 17 is a circuit diagram showing an internal configuration example of an existing ignition detection circuit;

FIG. 18 is a diagram showing an internal configuration example of an existing projector device; and

FIG. 19 is a diagram showing an existing example of disposing of an antenna lead with respect to a ballast power supply unit.

### DETAILED DESCRIPTION OF THE PREFERRED EMBODIMENTS

Before the description of a best mode (hereinafter, referred to as an embodiment) for carrying out the present invention, the background of the invention will be described below.

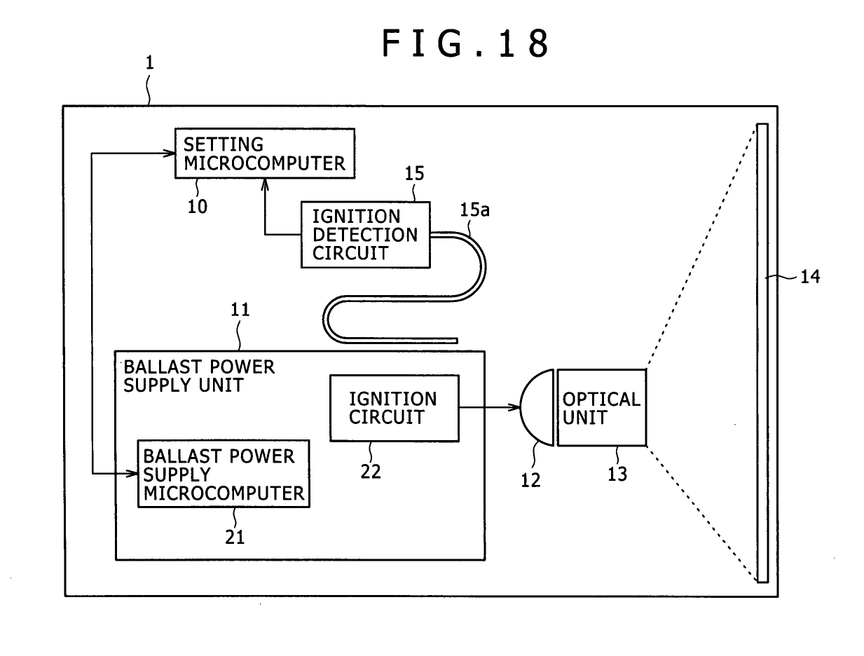

FIG. 18 shows a configuration example of an existing projector device 1. This diagram is to mainly show a configuration for driving a lamp 12 as a light source for the lighting thereof in the projector device 1.

An HID lamp is used for the lamp 12 as the light source in this device. Light emitted from the lamp 12 as the light source enters an optical unit 13. The optical unit 13 is configured to convert the incident light into color image light dependent upon a video signal, and project this color image light on the backside of a screen 14 in a magnified form. A user sees the screen 14 from the front side thereof, and thereby can view displayed images.

The lamp 12 is supplied with power from a ballast power supply unit 11 so as to be driven for the lighting thereof. The ballast power supply unit 11 is treated as one component device (component unit). In FIG. 18, a ballast power supply microcomputer 21 and an ignition circuit 22 are shown as functional parts included in the ballast power supply unit 11.

The ballast power supply microcomputer 21 is a microcomputer for controlling predetermined operation and so on of the ballast power supply unit 11.

The ignition circuit 22 is a circuit part for starting the ignition of the lamp 12 (activating the lamp 12), and applies a high voltage pulse (ignition pulse) to the lamp 12.

An ignition detection circuit 15 is a circuit part for detecting whether or not the ignition circuit 22 has operated normally for the activation, and outputs the detection signal to a setting microcomputer 10. The setting microcomputer 10 is a microcomputer for overall control of the entire projector device 1, and is coupled also to the ballast power supply microcomputer 21 so that they can communicate with each other for control of the ballast power supply unit 11.

The setting microcomputer 10 has a self-diagnosis function, and executes e.g. state notification (failure notification) regarding lamp lighting based on the detection signal output from the ignition detection circuit 15.

An antenna lead 15a is provided to the ignition detection circuit 15 in such a manner as to be routed out from the ignition detection circuit 15 as shown in the diagram. As the antenna lead 15a, e.g. a coated line obtained by coating a conductive lead having a predetermined length is used.

The ignition circuit 22 generates and outputs an ignition pulse in order to initiate the lighting of the lamp 12. In response to the output of the ignition pulse, a comparatively large current flows, and an induced voltage arises due to this current. The antenna lead 15a is to sense this induced voltage.

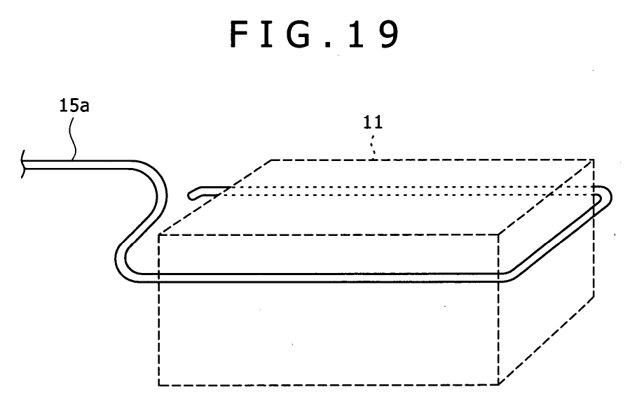

The ballast power supply unit 11 is constructed as one component device (component unit) in practice. The antenna lead 15a is provided, as shown in FIG. 19 for example, in such manner as to be routed around the main body of the ballast power supply unit 11 as the component unit and at such a position as to be capable of detecting an ignition pulse.

In the above-described existing configuration, the antenna lead 15a for the ignition detection is provided in such a manner as to be routed around the component unit as the ballast power supply unit 11 as shown in FIG. 19. However, the actual antenna lead 15a is formed of a thin coated line and therefore is soft, which makes it difficult for the antenna lead 15a itself to maintain its line shape fixedly. Accordingly, it is difficult to fix the antenna lead 15a at the prescribed position as it is. For that reason, in practice, the antenna lead 15a is attached by using an attaching member so that the position of the antenna lead 15a is defined with respect to the ballast power supply unit 11, although not shown in FIG. 19. In this manner, attachment of the actual antenna lead 15a demands an extra member for the attachment, which causes disadvantages of corresponding increases in the costs and the size of the component unit as the ballast power supply unit 11. Furthermore, the necessity of the attaching member causes also a disadvantage, in terms of manufacturing efficiency, that a process of fitting the antenna lead 15a into the attaching member becomes necessary.

Moreover, even if the attachment position of the antenna lead 15a is regulated by using an attachment member or the like as described above, due to flexibility of the antenna lead 15a and difficulty to strictly define the distance between the ignition circuit 22 in the ballast power supply unit 11 and the antenna lead 15a, variation in the detection sensitivity for an induced voltage in response to an ignition pulse is readily caused.

Furthermore, the attachment structure of the antenna lead 15a like that shown in FIG. 19 causes the antenna lead 15a to readily sense also e.g. unnecessary radiation noise other than an ignition pulse in practice.

In addition, in the internal configuration of the ignition detection circuit 15, it is necessary to detect and amplify an induced voltage obtained through the antenna lead 15a, and then output the resultant signal with latching it, although a more detailed description will be made later. The necessity for this latching causes a disadvantage that the actual circuit configuration for this latching is comparatively complicated and includes a large number of components.

Therefore, the present invention is to propose a configuration relating to the ignition detection for eliminating the above-described problems. An embodiment of the present invention will be described below.

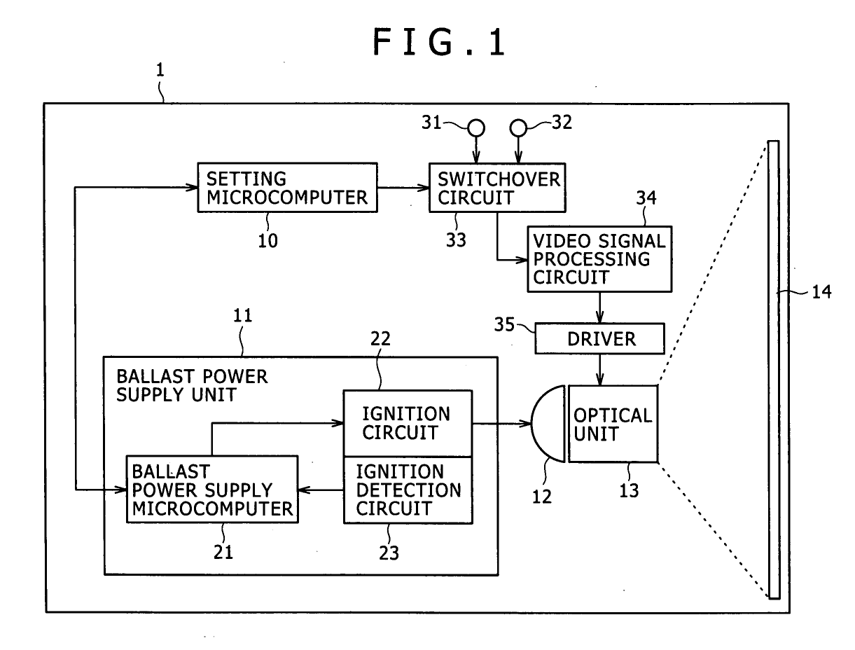

FIG. 1 schematically shows the entire configuration of a display device as an embodiment of the invention. The display device of the present embodiment is a so-called liquid crystal projector device that employs an HID lamp as a light source. This projector device modulates light arising from this light source by a liquid crystal panel and projects the resultant modulated light on a screen in a magnified form to thereby display images.

FIG. 1 mainly shows a configuration for driving an HID lamp 12 as a light source for the lighting thereof as the internal configuration of a projector device 1 of the present embodiment.

The projector device 1 causes light emitted from the lamp 12 as the light source to enter an optical unit 13. The optical unit 13 separates the incident light from the lamp 12 as the light source into component light rays of the respective colors of red (R), green (G) and blue (B) for example, and causes the component light rays to enter a liquid crystal panel that is a light modulation element for the respective colors of R, G and B, so that the light rays are modulated in the liquid crystal panel. The thus modulated light rays serve as image light rays corresponding to the respective colors of R, G and B. The thus obtained R, G and B image light rays are recombined, and the resultant light is projected through a projecting lens on the backside of a screen 14 in a magnified form. Thus, color images are displayed on the screen 14. A user of the projector device 1 sees the screen 14 from the front side thereof, and thereby can view the displayed images.

The device for driving an HID lamp like the lamp 12 for the lighting thereof has a function to supply the lamp with power for the lighting-drive, and therefore is referred to also as a ballast power supply. Also in the present embodiment, a ballast power supply unit 11 included in the projector device 1 drives the lamp 12 for the lighting thereof as shown in FIG. 1.

FIG. 1 shows a ballast power supply microcomputer 21 and an ignition circuit 22 as functional parts included in the ballast power supply unit 11, although a more specific internal configuration example of the ballast power supply unit 11 will be described later.

The ballast power supply microcomputer 21 is included inside the ballast power supply unit 11 and controls various kinds of operation in the ballast power supply unit 11.

To start the lighting of the lamp 12 (activate the lamp 12) as an HID lamp, a high voltage pulse needs to be applied to induce a discharge in the lamp, as is well known. The ignition circuit 22 is a circuit configured to generate the high voltage pulse (ignition pulse) in order to activate the lamp 12. The ignition circuit 22 is combined with drive circuitry for steadily driving the lamp 12 after the activation thereof, although not shown in the drawing.

In the present embodiment, an ignition detection circuit 23 is provided inside the ballast power supply unit 11. The function of the ignition detection circuit 23 in this embodiment is also to detect the normality of the operation of the ignition circuit 22. Furthermore, the ballast power supply unit 11 in the present embodiment is also constructed as a single component device (component unit). It follows that the present embodiment employs a physical structure in which the ignition circuit 22 and the ignition detection circuit 23, which detects the normality of the operation of the ignition circuit 22, are included in the same component unit. In this configuration, the detection output of the ignition detection circuit 23 is input to the ballast power supply microcomputer 21.

Furthermore, a setting microcomputer 10 is shown in FIG. 1.

The setting microcomputer 10 executes overall control of the entire operation in the projector device 1, and in practice, executes user interface control, input/output control of video, audio and so on, display control, and other kinds of control. Furthermore, the setting microcomputer 10 can execute also control operation relating to the ballast power supply unit 11 by cooperating with the ballast power supply microcomputer 21.

For the video input control, the projector device 1 is provided with video input terminals 31 and 32, a switchover circuit 33, a video signal processing circuit 34, and a driver 35. The setting microcomputer 10 selects a video signal input to one of the video input terminals 31 and 32 and supplies the selected signal to the video signal processing circuit 34, followed by decoding and A/D conversion therein. The resultant signal is supplied to the driver. The driver is driven so that voltages are applied to the respective pixels of the liquid crystal panel.

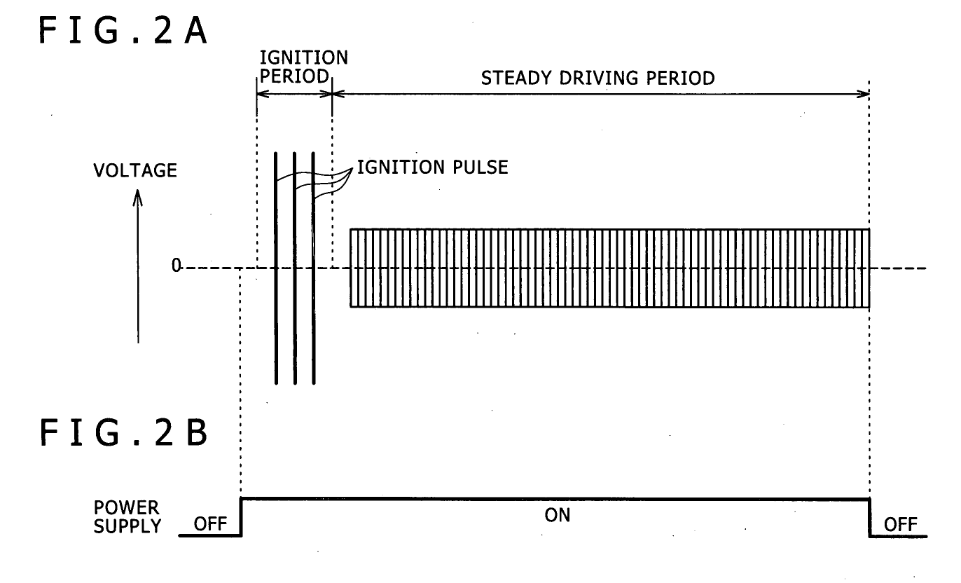

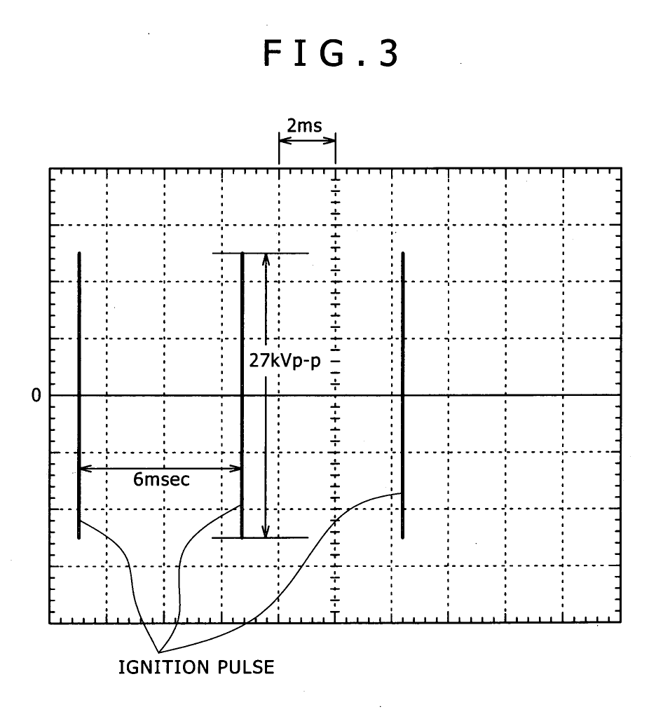

The concept of the driving of the lamp 12 (HID lamp) will be described below with reference to FIGS. 2A, 2B and 3.

FIGS. 2A and 2B show a timing chart relating to the driving of the lamp 12.

When the power supply of the projector device 1 is switched from the off-state to the on-state as shown in FIG. 2B, the setting microcomputer 10 instructs the ballast power supply microcomputer 21 to light the lamp 12 for example.

In response to this instruction, the ballast power supply microcomputer 21 controls the ballast power supply unit 11 so that a drive voltage (power) is supplied to the lamp 12 as shown in FIG. 2A for example.

Referring to FIG. 2A, an ignition period is set as an initial period. In the ignition period, a high voltage pulse called an ignition pulse is applied to the lamp 12 several times.

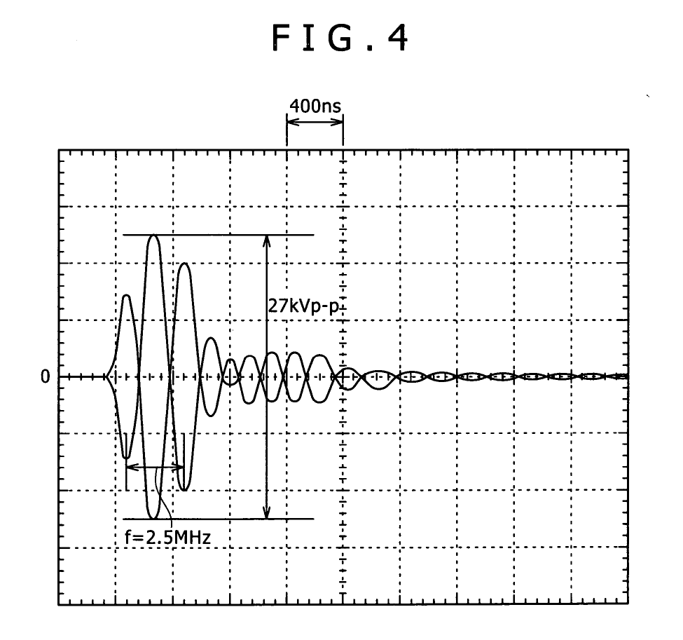

As shown in FIG. 3, this ignition pulse is generated with intervals of e.g. about 6 ms and has a high peak value higher than 20 kV (27 kvp-p, in FIG. 3). FIG. 4 shows the output period of one ignition pulse in an enlarged form. As shown in FIG. 4, the ignition pulse has a sinusoidal waveform with a frequency of e.g. 2.5 MHz.

The application of an ignition pulse in the above-described manner starts a discharge inside the lamp 12. When the state where a discharge is started has been achieved, as shown in FIG. 2A, the operation of applying an ignition pulse (activation operation) by the ignition circuit 22 is stopped, so that the period sequence proceeds to a steady driving period and the operation is switched to steady operation of supplying the lamp with constant power based on an AC voltage having a predetermined frequency.

If the main power supply is turned off for example, the supply of the constant power to the lamp 12 is stopped so that the lighting of the lamp 12 is also stopped.

Although the reason why the projector device 1 of the present embodiment should be provided with the ignition detection function is the same as that for the existing configuration shown in FIGS. 18 and 19 for example, this reason will be described below anew.

For a projector device like that shown in FIG. 1, the state where the lamp 12 fails to be lit should be assumed as one of breakdown cases. As the causes of the failure of the lighting of the lamp 12, two causes would be possible in a rough classification: trouble with the lamp 12 itself and trouble with the ballast power supply unit 11 for driving the lamp 12.

Therefore, it is preferable to allow the projector device to identify which of the lamp itself and the set including the ballast power supply unit involves the cause when actually a breakdown of failure of the lighting of the lamp 12 has occurred, because the cause can be identified easily.

The ignition detection circuit 23 corresponding to the ignition detection function is provided in order to determine the normality of the operation of the ballast power supply unit 11 (set) in consideration of the above-described reason.

For a determination as to whether or not the lamp 12 is in the lighting state, the ballast power supply microcomputer 21 monitors the operation state of a predetermined part in the ballast power supply unit 11 to thereby make the determination. A specific example of this determination operation will be described later.

As described above, the ballast power supply microcomputer 21 can make a determination as to the normality of the operation of the ignition circuit 22 based on the output of the ignition detection circuit 23 and determine whether or not the lamp 12 is in the lighting state. Based on these two determination results, the ballast power supply microcomputer 21 can roughly estimate the cause of failure of the lighting of the lamp 12.

If a determination result that the lamp 12 is not in the lighting state has been obtained although it has been determined that the ignition circuit 22 is normally operating for example, the ballast power supply microcomputer 21 can estimate that the ballast power supply unit 11 (set) is normal while the lamp 12 independently has a breakdown.

If it has been determined that the ignition circuit 22 is not normally operating and it has been determined that the lamp 12 is not in the lighting state, it is estimated that at least the ballast power supply unit 11 (set) has a breakdown.

Based on the estimation result, the ballast power supply microcomputer 21 of the present embodiment outputs a message notifying the state of lamp lighting to the setting microcomputer 10. For example, if an estimation result that the lamp 12 independently has a breakdown has been obtained as described above, the ballast power supply microcomputer 21 outputs a message indicating that. If an estimation result that at least the ballast power supply unit 11 (set) has a breakdown has been obtained, the ballast power supply microcomputer 21 outputs a message indicating that. Furthermore, in response to an estimation result that neither the lamp 12 nor the ballast power supply unit 11 (set) has a breakdown, the ballast power supply microcomputer 21 outputs a message indicating the normality.

The setting microcomputer 10 has a self-diagnosis function, and executes control so that an indication to notify a user of the state corresponding to the input message is implemented through e.g. blinking of an indication element such as an LED.

Configuration examples for the ignition detection according to the present embodiment will be described below.

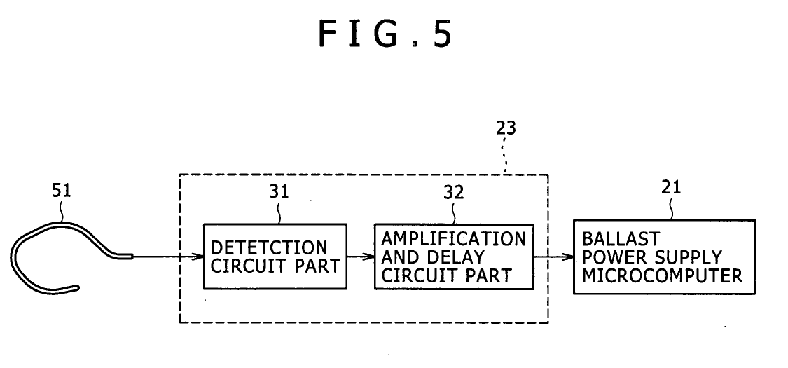

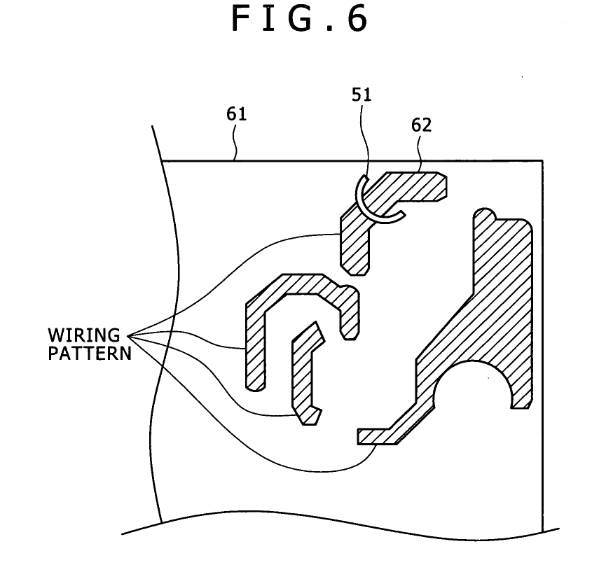

Initially, a first configuration example for the ignition detection will be described with reference to FIGS. 5 and 6.

In the first example, as shown in FIG. 5, a simplified antenna line 51 is provided and one end thereof is coupled to the input of a detection circuit part 31 in the ignition detection circuit 23.

In FIG. 5, the internal configuration of the ignition detection circuit 23 of the present embodiment is shown so that the ignition detection circuit 23 is regarded as being composed of the detection circuit part 31 and an amplification and delay circuit part 32.

The simplified antenna line 51 is disposed in the ballast power supply unit 11 as shown in FIG. 6 for example.

A substrate (printed wiring board) 61 shown in FIG. 6 is included in the ballast power supply unit 11. In FIG. 6, of the substrate 61, part where a wiring pattern near the circuit part as the ignition circuit 22 is formed is shown in a focused manner. The wiring pattern is formed of e.g. a copper foil and obtained through etching treatment and so on.

Because the ignition circuit 22 generates an ignition pulse to activate the lamp also as described above, the wiring pattern actually formed on the substrate contains the part through which a current in response to the ignition pulse (ignition current: activation current) flows. In FIG. 6, a detection line pattern 62 is defined as the wiring pattern through which the activation current flows.

In the first example, the simplified antenna line 51 is disposed in such a manner as to be stretched across the detection line pattern 62. Due to this configuration, when an ignition current flows through the detection line pattern 62 in response to generation of an ignition pulse, an induced voltage arising in response to the ignition current is sensed by the simplified antenna line 51.

The induced voltage thus sensed by the simplified antenna line 51 is detected by the detection circuit part 31 in the ignition detection circuit 23 shown in FIG. 5. The amplification and delay circuit part 32 is supplied with the detection output obtained by the detection circuit part 31 and amplifies it. Furthermore, the amplification and delay circuit part 32 gives a predetermined delay to the detection output and outputs to the ballast power supply microcomputer 21 the resultant signal as the detection output of the ignition detection circuit 23.

According to the above-described configuration of the ignition detection circuit 23, if the ignition circuit 22 has operated normally to generate an ignition pulse, a DC voltage of a predetermined value is output. In contrast, if the ignition circuit 22 is in such an abnormal operation state that an ignition pulse cannot be properly output therefrom, the 0 level is output because the detection output fails to be obtained. In this manner, the ignition detection circuit 23 outputs different signals depending on whether or not the operation of the ignition circuit 22 is normal. Furthermore, the ballast power supply microcomputer 21 captures therein this signal and senses the value of the signal, and thereby can determine whether the ignition circuit is normal or abnormal.

A description will be made on the reason why the output of the ignition detection circuit 23 of the present embodiment should be delayed by the amplification and delay circuit part 32.

The procedure of the lamp activation from the viewpoint of the ballast power supply microcomputer 21 is as follows. Specifically, initially the ballast power supply microcomputer 21 executes control so that the ignition circuit 22 starts the operation, and then captures therein the detection signal output from the ignition detection circuit 23 at predetermined timing set in the microcomputer 21 itself.

That is, a certain degree of time lag arises between the start of the operation of the ignition circuit 22 and the timing of the capturing of the detection signal by the ballast power supply microcomputer 21. Therefore, in consideration of this time lag, the detection output is delayed so that the ballast power supply microcomputer 21 can capture therein the detection signal from the ignition detection circuit 23 at proper timing. However, this time lag is considerably small, and hence a very short time is sufficient as the delay time. If the delay time is defined by e.g. a time constant circuit, a small value is enough as the time constant thereof.

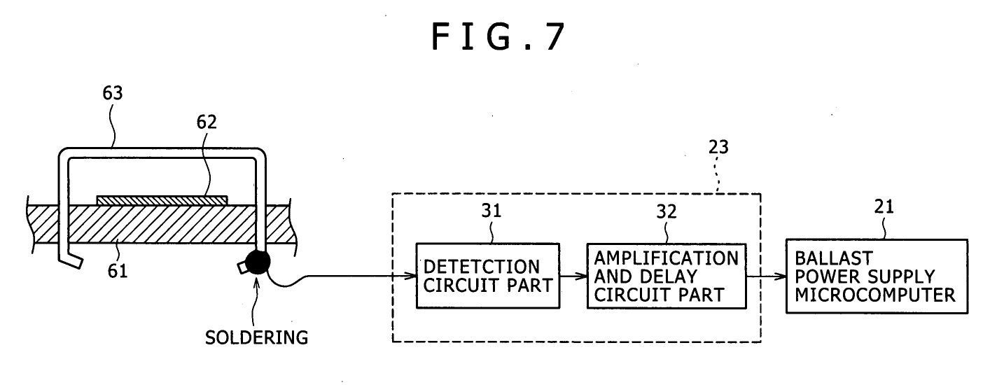

Note that the configuration of the ignition detection circuit shown in FIG. 5 is the same as that in FIGS. 7, 9, 10 and 12, which will be described later.

A comparison between the configuration of the first example shown in FIGS. 5 and 6 and the existing configuration leads to the following conclusion.

In the present embodiment, as shown in FIG. 6, the simplified antenna line 51 can be provided on the substrate 61 with being brought very close to the detection line pattern 62, through which an ignition current flows. This placement way eliminates the need to employ a large-scale structure in which a comparatively long coated lead like e.g. the existing antenna lead 15a is fixed with an attaching member or the like. Therefore, the present embodiment can contribute to e.g. cost down and causes no increase in the component size of the ballast power supply unit 11. In addition, the simplified antenna line 51 can be disposed at an almost proper position with respect to the detection line pattern 62, through which an ignition current flows. Thus, variation in the detection sensitivity for an induced voltage is greatly suppressed compared with the existing configuration. Furthermore, the simplified antenna line 51 is significantly shorter than the existing antenna lead 15a and is included in the component unit as the ballast power supply unit 11. These features offer a shielding effect against external noise, which dramatically improves the anti-noise performance.

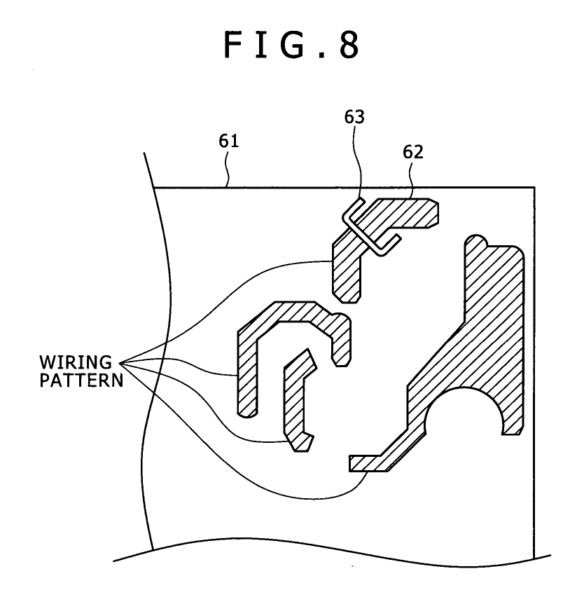

A second configuration example for the ignition detection of the present embodiment will be described below with reference to FIGS. 7 and 8.

In the second configuration example, as shown in FIGS. 7 and 8, a jumper line 63 is fixedly attached to the substrate 61 in such a manner as to be stretched across the detection line pattern 62. Furthermore, one end of the jumper line 63 is coupled by soldering or the like to the input of the detection circuit part 31 in the ignition detection circuit 23.

In this configuration, similarly to the simplified antenna line 51 of the first configuration example, the jumper line 63 functions as an antenna and thus can sense an induced voltage generated due to an ignition current flowing through the detection line pattern 62.

Furthermore, a lead component or the like is used as the jumper line in general. Therefore, providing the jumper line with e.g. a form like that shown in FIG. 7 allows the jumper line to hold the form. Thus, variation in the detection sensitivity for an induced voltage can be further suppressed for example.

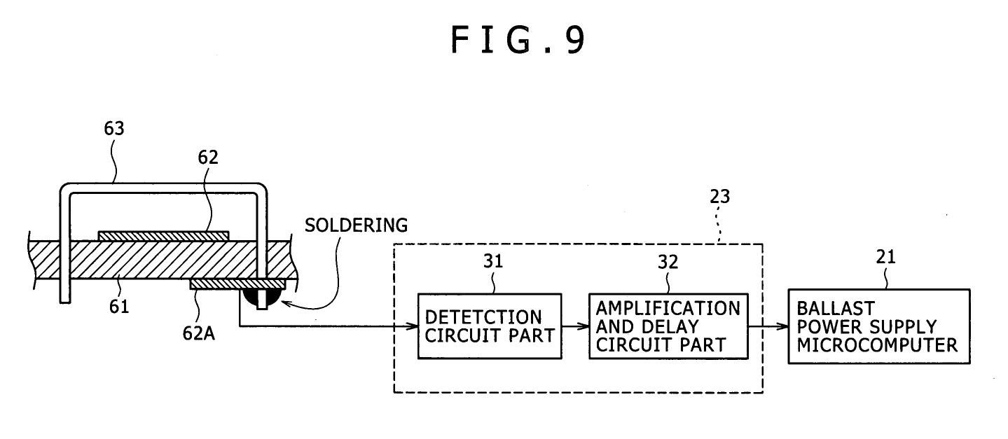

FIG. 9 shows a third configuration example for the ignition detection of the present embodiment. The same parts in FIG. 9 as those in FIG. 7 for the second example are given the same numerals and a description thereof is omitted. Furthermore, the form of the third example when the substrate 61 is viewed from the side on which the jumper line 63 is visible is the same as that in FIG. 8.

The structure shown in this drawing is based on an assumption that the substrate 61 is e.g. a double-sided board or multilevel substrate in which writing patterns are formed on both the front and back sides thereof. In this case, the side on which the detection line pattern 62 is formed is defined as the front side, and a backside pattern 62A is formed on the back side. In addition, the backside pattern 62A and the jumper line 63 are connected and fixed to each other by soldering or the like, and the backside pattern 62A and the input of the detection circuit part 31 are coupled to each other by a lead or the like.

In this structure, as actual operation for coupling the input of the detection circuit part 31 to the jumper line 63, a lead routed out from the input of the detection circuit part 31 is soldered to the backside pattern 62A. Providing the backside pattern 62A with an area larger than a certain area facilitates the soldering operation.

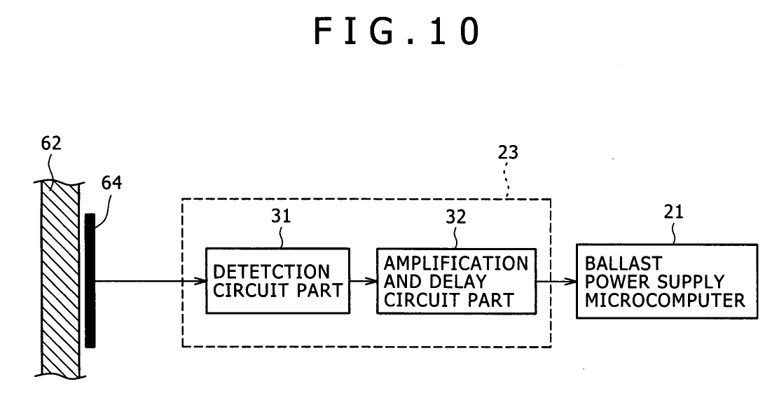

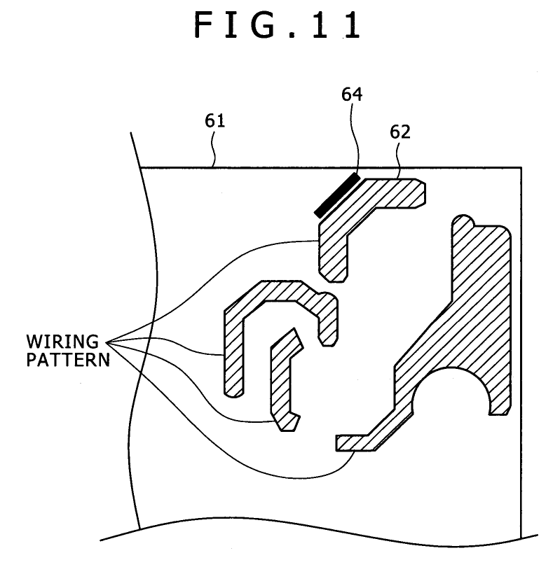

FIGS. 10 and 11 show a fourth configuration example for the ignition detection of the present embodiment.

In the configuration shown in these drawings, an antenna pattern 64 is formed along part of the detection line pattern 62 formed on the substrate 61. This antenna pattern 64 is also formed in the step of forming the wiring pattern on the substrate 61, similarly to the detection line pattern 62. In this example, the antenna pattern 64 senses an induced voltage dependent upon an ignition current flowing through the detection line pattern 62 similarly to the simplified antenna line 51 and the jumper line 63 in the above-described examples. Therefore, if one end of the antenna pattern 64 is coupled to the input of the detection circuit part 31 as shown in FIG. 10, the ignition detection circuit 23 can detect the normality of the operation of the ignition circuit 22 similarly to the above-described examples.

In this configuration, there is no need to separately prepare and provide a sensing member for sensing an induced voltage because the antenna pattern 64 has been formed as a part of the printed wiring pattern on the substrate. Therefore, this configuration is economic and the formation thereof is easy. Moreover, the antenna pattern 64 is planarly formed on the substrate, which eliminates the need to assure a height space for a sensing member and offers the highest flexibility in mounting space design.

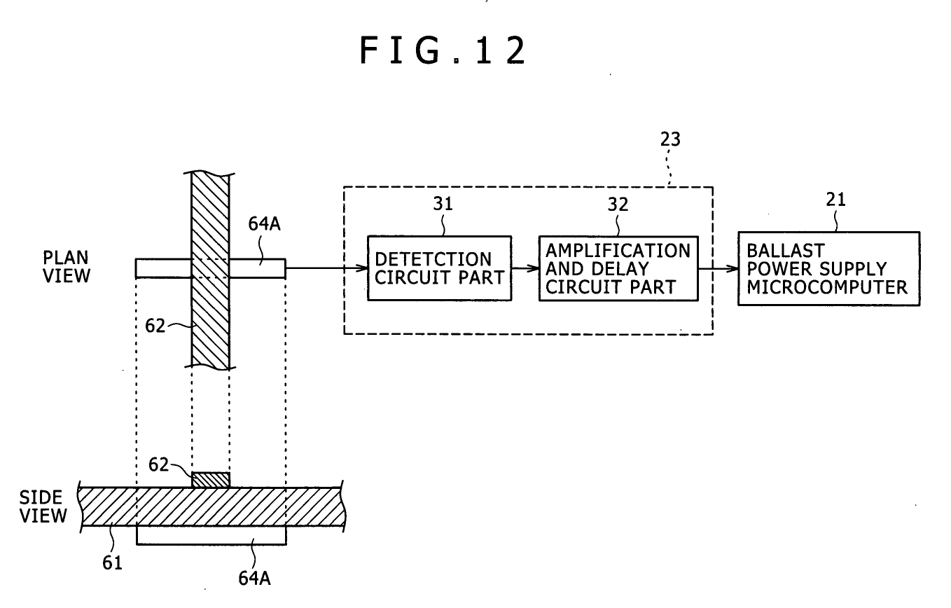

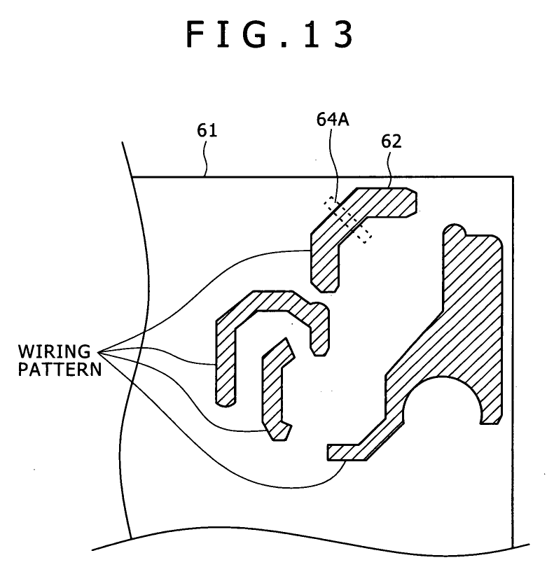

FIGS. 12 and 13 show a fifth configuration example for the ignition detection of the present embodiment. The configuration shown in these drawings is also based on an assumption that the substrate 61 is e.g. a double-sided board or multilevel substrate in which writing patterns are formed on both the front and back sides thereof.

In this case, on the substrate 61, an antenna pattern 64A is formed on the side opposite to the side on which the detection line pattern 62 is formed. In this example, the longitudinal direction of the detection line pattern 62 and that of the antenna pattern 64A are almost perpendicular to each other. The thus formed and disposed antenna pattern 64A also can sense an induced voltage generated in response to an ignition current flowing through the detection line pattern 62 similarly to the simplified antenna line 51 and the jumper line 63 in the above-described examples. For example, depending on the way of forming the wiring pattern on the substrate surface having thereon the detection line pattern 62, a case is possible where it is difficult due to space limitation to form the antenna pattern 64 on the same surface as that of the detection line pattern 62 like in the example of FIG. 11. In this case, employing the fifth example is effective.

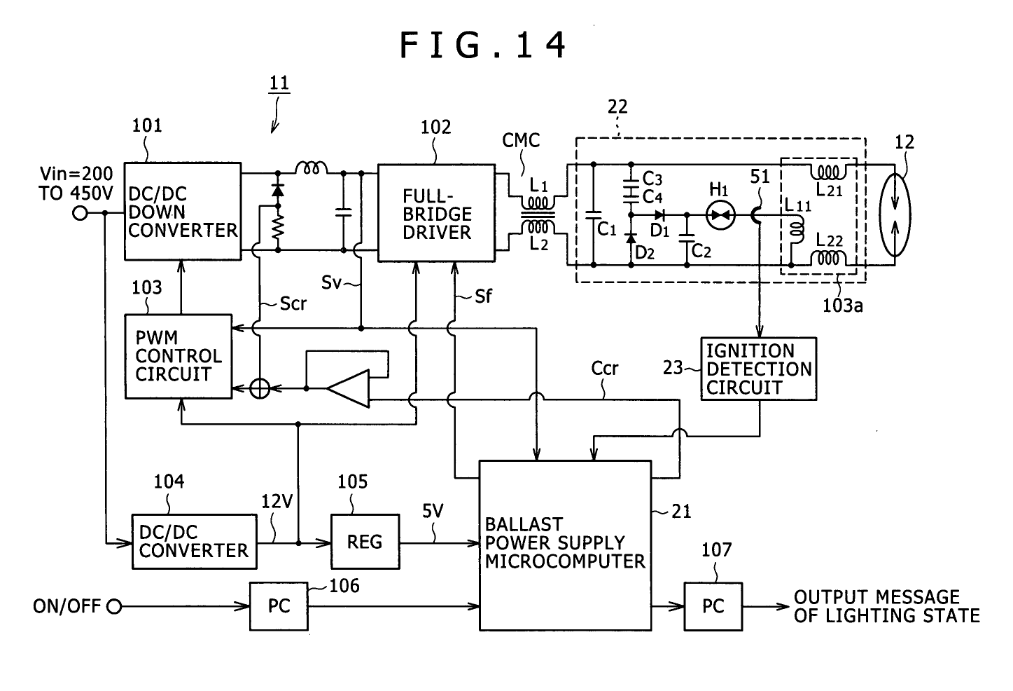

FIG. 14 shows an internal circuit configuration example of the ballast power supply unit 11, corresponding to the case where any of the configurations of the first to fifth examples for the ignition detection described with FIGS. 5 to 13 is employed. Note that this diagram shows the case where the configuration of the first example for the ignition detection is employed.

The ballast power supply unit 11 is supplied with a DC input voltage Vin with a defined level in the range of 200 V to 450 V. This voltage Vin is input to a DC/DC down converter 101. Furthermore, the input voltage Vin is branched and input also to a DC/DC converter 104 to be described later.

The DC/DC down converter 101 includes a switching converter, and implements DC-DC power conversion for the input voltage Vin to thereby output a DC voltage with a defined level lower than the input voltage Vin. This DC voltage output passes through lines connected to an inductor, capacitor and so on, followed by being input to a full-bridge driver 102.

The full-bridge driver 102 includes a full-bridge switching converter formed of four switching elements (circuits) such as FETs (field effect transistors). The full-bridge driver 102 is supplied with the direct current input from the DC/DC down converter 101 and implements switching operation therefor to thereby output an alternating current having a rectangular waveform.

The AC output of the full-bridge driver 102 is applied to the lamp 12 via a common mode choke coil CMC and the ignition circuit 22. That is, the lamp 12 is driven for the lighting thereof by being supplied with AC power from the full-bridge driver 102.

The ignition circuit 22 produces an ignition pulse for activating the lamp 12 and applies it to the lamp 12 also as described above. The operation for producing an ignition pulse by the ignition circuit 22 shown in this diagram will be described later. The detection line pattern 62 shown in e.g. FIG. 6 corresponds to, in FIG. 14, the line at the position between a discharge tube (spark gap) H1 and a primary winding L11 in an igniter 103a. FIG. 14 shows that the simplified antenna line 51 is disposed near the position of the line. Also in this diagram, one end of the simplified antenna line 51 is coupled to the input of the ignition detection circuit 23, and the output of the ignition detection circuit is input to the ballast power supply microcomputer 21.

As described later, when the lamp 12 is driven for the steady lighting thereof after the activation thereof, constant power is supplied to the lamp 12. For this purpose, a PWM control circuit 103 is provided to execute the constant power control.

To the PWM control circuit 103, a sensed voltage Sv obtained by sensing the voltage of the output line from the DC/DC down converter 101 is input. Furthermore, input to the PWM control circuit 103 is the value resulting from addition, in an adder, of a sensed current Scr obtained by sensing the current flowing through the output line from the DC/DC down converter 101 to a current value signal Ccr output from the ballast power supply microcomputer 21. The PWM control circuit 103 implements PWM control of the switching operation of the DC/DC down converter 101 with use of these feedback inputs, so that constant power is supplied to the lamp 12 as a result of the PWM control.

The DC/DC converter 104 is supplied with the input voltage Vin and subjects it to power conversion, to thereby produce and output a DC voltage of e.g. about 12 V. This DC voltage is supplied to the PWM control circuit 103, the full-bridge driver 102 and so on. Furthermore, the DC voltage is stabilized to a voltage of 5 V by a regulator 105, followed by being supplied to the ballast power supply microcomputer 21 as the operating voltage therefor.

The ballast power supply microcomputer 21 is allowed to capture therein an ON/OFF signal output from e.g. the setting microcomputer 10 via a photo coupler 106. This ON/OFF signal is e.g. a signal indicating the ON/OFF of the main power supply of the projector device.

When this ON/OFF signal is changed from the state indicating OFF to that indicating ON for example, the ballast power supply microcomputer 21 causes the ignition circuit 22 to operate so that an ignition pulse is produced and applied to the lamp 12, to thereby start the lighting of the lamp 12, as described later.

In addition, the ballast power supply microcomputer 21 outputs a message notifying the state regarding the lamp lighting also as described above. This message is output via e.g. a photo coupler 107.

The operation of the ignition circuit 22 shown in FIG. 14 will be described below.

Initially, when the ballast power supply microcomputer 21 has sensed the switching-on of the main power supply through the signal captured therein via the photo coupler 106, the ballast power supply microcomputer 21 issues an instruction to set the frequency of the full-bridge driver 102 to e.g. about 100 kHz for lamp activation. A frequency control signal Sf is used for this instruction. This instruction induces an ignition pulse producing operation by the ignition circuit 22. That is, the instruction serves as a trigger for operating the ignition circuit 22 to activate the lamp 12.

In response to this instruction, the full-bridge driver 102 implements switching with a switching frequency of about 100 kHz to thereby output an AC voltage. This AC voltage passes through inductors L1 and L2 of the common mode choke coil CMC, followed by being supplied to the ignition circuit 22.

At the input stage of the ignition circuit 22, a capacitor C1 is connected in parallel to the lines of both the polarities. When the alternating current output from the full-bridge driver 102 has the above-described frequency of 100 kHz for ignition, a resonant circuit is formed by the capacitor C1 and the inductors L1 and L2 in the common mode choke coil CMC. The resonant output is rectified by a rectifier circuit part formed of capacitors C3 and C4 and diodes D1 and D2, followed by being charged to a capacitor C2.

When the voltage across the capacitor C2 becomes higher than a certain value (e.g., higher than 800 V) as a result of this charging of the capacitor C2, a discharge is generated in the discharge tube H1 connected to the capacitor C2. Upon the generation of a discharge in the discharge tube H1, a pulse current flows through the primary winding L11 in the igniter 103a via the discharge tube H1. Along with this current flow, a pulse of 20 kV or higher like that shown in e.g. FIGS. 3 and 4 is generated in secondary windings L21 and L22 in the igniter 103a, followed by being applied to the electrodes of the lamp 12. This pulse corresponds to an ignition pulse and induces a discharge in the lamp 12.

The ignition circuit 22 repeats the above-described operation several times until the lamp 12 enters the discharge state for example, in response to the application of the alternating current (100 kHz) for activation from the full-bridge driver 102. That is, the operation corresponding to the ignition period in FIG. 2 is achieved.

In this period during which the ignition circuit 22 operates in the above-described manner, a discharge current with a large level flows from the capacitor C2 toward the inductor L11 almost simultaneously with the generation of the ignition pulse, as is apparent from the above-described operation explanation. This current serves as the ignition current thus far described. Detecting this ignition current allows a determination as to whether or not an ignition pulse is generated. For this detecting, in the present embodiment, a sensing member such as the simplified antenna line 51, the jumper line 63 or the antenna pattern 64 is disposed near the detection line pattern 62 on the substrate, equivalent to the line through which the ignition current flows, to thereby sense an induced voltage generated due to flowing of the ignition current.

It should be stated for confirmation that, in FIG. 14, the line interconnecting the discharge tube H1 and the primary winding L11 in the igniter 103a is defined as the circuit part corresponding to the detection line pattern 62 on the substrate, equivalent to the line through which the ignition current flows, and a sensing member such as the simplified antenna line 51 is disposed near this line. However, the line is not limited thereto. Specifically, any part may be used as the detection line pattern 62 on the substrate, near which a sensing member is disposed, as long as the part is the wiring pattern corresponding to the line part through which an ignition current flows. For example, in the circuit configuration of FIG. 14, an ignition current flows also through the line between the capacitor C2 and the discharge tube H1 similarly. Therefore, a configuration is also available in which the wiring pattern corresponding to this line is defined as the detection line pattern 62 and a sensing member is disposed near this line.

At the timing when the lamp 12 has entered the discharge state and thus the lighting thereof is started due to the above-described activation operation, the ballast power supply microcomputer 21 issues an instruction by the frequency control signal Sf to change the switching frequency of the full-bridge driver 102 from 100 kHz to e.g. 180 Hz.

In response to the instruction, the frequency of the alternating current output from the full-bridge driver 102 is switched to 180 Hz. This frequency does not cause the resonant operation by the capacitor C1 and the inductors L1 and L2 in the ignition circuit 22, and therefore the above-described AC output of 180 Hz is applied to the lamp 12. This application of the AC voltage continues the subsequent discharge state inside the lamp 12. That is, this state corresponds to the steady driving period in FIG. 2, during which the lamp is continuously driven for the lighting thereof.

In this steady driving state, as described above, the PWM control circuit 103 executes control so that power supplied to the lamp 12 is kept constant. For this constant power control, the ballast power supply microcomputer 21 captures therein the sensed voltage Sv and determines the target current value dependent upon the sensed voltage value. Subsequently, the microcomputer 21 outputs the current value signal Ccr as a signal indicating the target current value. The PWM control circuit 103 implements PWM control also in consideration of this current value signal Ccr, which allows power supplied to the lamp 12 to be kept constant.

Furthermore, in the ignition period, the ballast power supply microcomputer 21 captures therein the detection output from the ignition detection circuit 23. This allows the ballast power supply microcomputer 21 to determine whether or not the ignition circuit 22 has operated normally.

In addition, the ballast power supply microcomputer 21 captures therein e.g. the sensed voltage Sv and compares the sensed voltage value with a predetermined threshold value. If the voltage value is equal to or higher than the threshold value, the microcomputer 21 determines that the lamp 12 is lit. If it is lower than the threshold value, the microcomputer 21 determines that the lamp 12 is not lit.

Subsequently, by using this determination result, the ballast power supply microcomputer 21 estimates the state regarding the lighting of the lamp 12 and outputs a message indicating the state to the setting microcomputer 10 as described above.

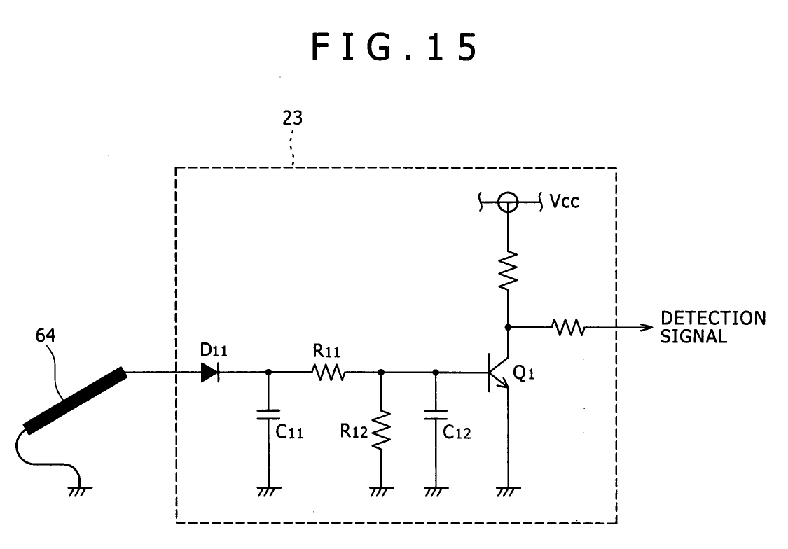

FIG. 15 shows a more specific circuit configuration example of the ignition detection circuit 23 of the present embodiment. Although this diagram shows the antenna pattern 64 corresponding to the above-described fourth or fifth example as a sensing member, using another sensing member also imposes no particular problem on the employment of the configuration shown in FIG. 15 for the ignition detection circuit 23.

When an induced voltage dependent upon an ignition current is sensed by the antenna pattern 64 (sensing member), this induced voltage is input to the ignition detection circuit 23 as an alternating voltage. In the ignition detection circuit 23, the input alternating voltage is detected by a detection circuit (rectifier circuit) formed of a diode D11 and a capacitor C11, followed by being supplied to the base of a transistor Q1 via a time constant circuit formed of a resistor R11 (and R12) and the capacitor C11. When being provided with a base potential higher than a certain level, the transistor Q1 conducts to output a detection signal as an amplified output from the collector.

Due to this circuit configuration, the ignition detection circuit 23 of the present embodiment outputs a detection signal at the timing later by the delay time dependent upon the time constant of the time constant circuit (the resistor R1 (and R12) and the capacitor C11) than the timing when an induced voltage dependent upon an ignition current is sensed by a sensing member. The above description makes it apparent that the ignition detection circuit 23 has a configuration obtained by combining a functional circuit part as the detection circuit part 31 with a functional circuit part as the amplification and delay circuit part as shown in FIG. 5 and so on.

The purpose of offering a delay time by the ignition detection circuit 23 is to match the timing of capturing of a detection signal in the ballast power supply microcomputer 21 with the timing of output of the detection signal from the ignition detection circuit 23.

A comparison will be made between the ignition detection circuit 23 of the present embodiment having the above-described configuration and an existing ignition detection circuit.

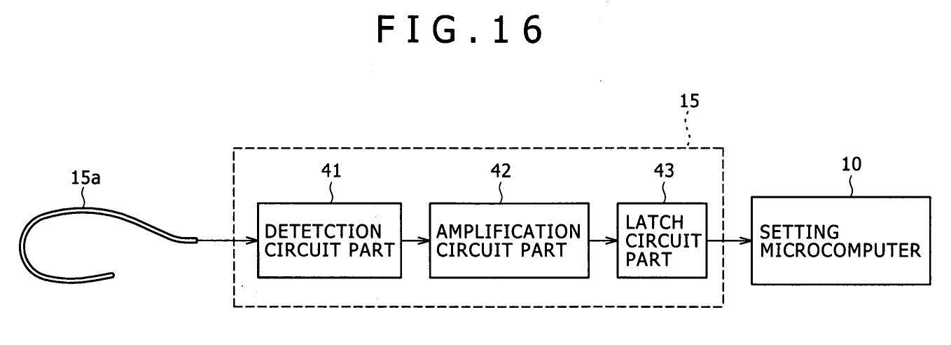

FIG. 16 is a block diagram showing the internal configuration of the ignition detection circuit 15 included in e.g. the configuration shown in FIG. 18. As shown in this diagram, the ignition detection circuit 15 includes a detection circuit part 41, an amplification circuit part 42, and a latch circuit part 43.

An induced voltage that is sensed by the antenna lead 15a and depends on an ignition current is detected by the detection circuit part 41 and then is amplified by the amplification circuit part 42. The output from the amplification circuit part 42 is latched by the latch circuit part 43 and is output to the setting microcomputer 10 as a detection signal.

As described above, in the existing ignition detection circuit 15, when an induced voltage dependent upon an ignition current is sensed, the detection signal is latched so that the output of the detection signal is continued also after the end of the ignition period for example. The reason why the configuration to thus latch a detection signal is employed is as follows.

According to FIG. 18, the ignition detection circuit 15 is shown as a functional circuit block separate from the setting microcomputer 10 and the ballast power supply microcomputer 21. This indicates that the ignition detection circuit 15 is included in the projector device 1 as an independent single component separate from the setting microcomputer 10 and the ballast power supply microcomputer 21. In the present embodiment, the ignition detection circuit 23 is included in the ballast power supply unit 11, which allows a configuration in which a detection signal of the ignition detection circuit 23 is input to the ballast power supply microcomputer 21. In contrast, in the case of the configuration like that shown in FIG. 18, the setup, integration and so on of circuits and components are easier when a detection signal from the ignition detection circuit 15 is input to setting microcomputer 10 rather than when it is input to the ballast power supply microcomputer 21. Furthermore, also in consideration of the fact that control for finally notifying the external of the lamp lighting state is implemented by the setting microcomputer 10, it is more preferable that a detection signal by the ignition detection circuit 15 is output to the setting microcomputer 10.

However, this configuration in which a detection signal from the ignition detection circuit 15 is input to the setting microcomputer 10 involves the following disadvantage.

Control for activating the ignition circuit 22 to start the lighting of the lamp is executed by the ballast power supply microcomputer 21 in the ballast power supply unit 11 in response to an instruction from the setting microcomputer 10. In this case, because the ballast power supply microcomputer 21 directly controls the ignition circuit 22 for the activation thereof, the setting microcomputer 10 cannot accurately grasp the timing when the ignition circuit 22 is activated but can only estimate a time width of a certain degree of length, including this timing. Furthermore, the setting microcomputer 10 captures therein a detection signal from the ignition detection circuit 15 with a time interval of a certain degree of length, depending on the processing performance of the setting microcomputer 10. Therefore, if the ignition detection circuit 15 is not allowed to have any configuration other than one to merely output a detection signal only at the timing corresponding to generation of an ignition pulse (ignition current) for example, when the timing of capturing of a detection signal in the setting microcomputer 10 is shifted from the timing of output of the detection signal, a determination result that the ignition circuit 22 is abnormal is obtained although it is normal.

To address this problem, the existing configuration latches the output of a detection signal and continuously outputs it, to thereby allow the setting microcomputer 10 to capture therein the detection signal normally.

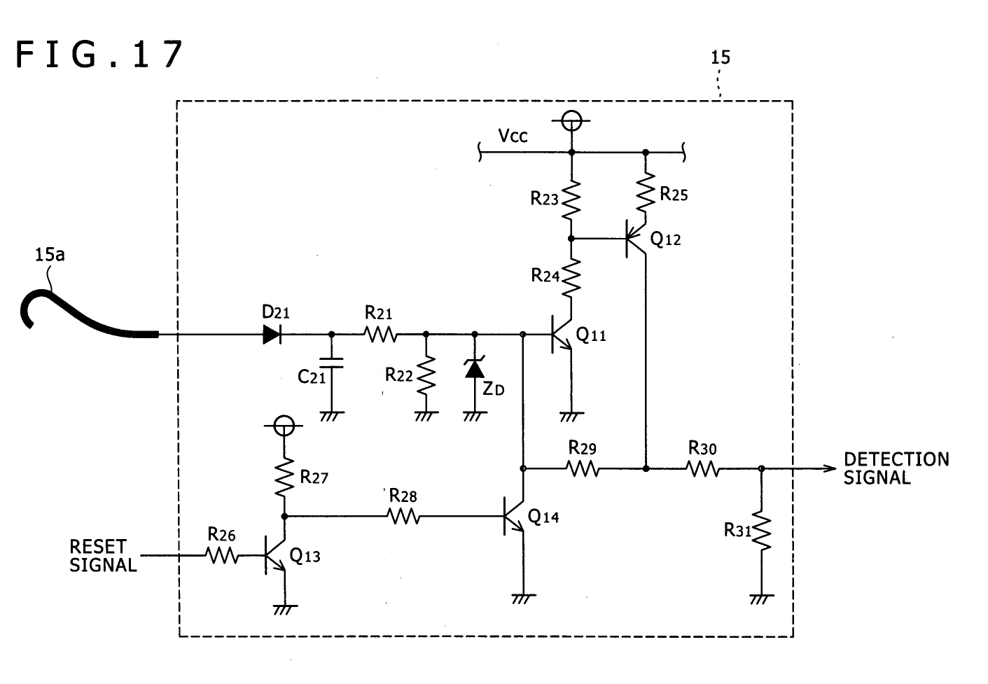

FIG. 17 shows a more specific configuration example of the existing ignition detection circuit 15.

An induced voltage that is sensed by e.g. the antenna lead 15a and depends on an ignition current is input as an alternating voltage, followed by being detected by a detection circuit formed of a diode D21 and a capacitor C21. The output of this detection circuit is supplied with a certain base potential by resistors R21 and R22 and a zener diode ZD and then is applied to a transistor Q11, which turns on the transistor Q11.

The turning-on of the transistor Q11 leads to turning-on of a transistor Q12, and the voltage resulting from division of the collector output of the transistor Q12 by resistors R30 and R31 is output as a detection signal.

Even after the input of the alternating voltage from the antenna lead 15a has been stopped, the transistor Q12 maintains its conducting state during a certain period dependent upon the time constant of the capacitor C21 and the resistor R21 (and R22). That is, the detection signal is latched.

However, in some case, it is not preferable to output a latched detection signal also in a period subsequent to the timing when the setting microcomputer 10 has surely completed capturing of the detection signal from the ignition detection circuit 15. Therefore, a reset circuit is also included in the actual ignition detection circuit 15.

The reset circuit in this example is formed of transistors Q13 and Q14, peripheral resistor elements and so on.

For example, at timing subsequent to the completion of capturing of a detection signal by the setting microcomputer 10, an H-level reset signal is output from the setting microcomputer 10. When the transistors Q13 and Q14 conduct in response to the input of this reset signal, the base of the transistor Q11 is supplied with the ground potential, and the collector of the transistor Q12 is also connected to the ground via a resistor R29. Thus, after this operation, the transistor Q12 is in the off-state and hence the collector output thereof is stopped, which stops also the output of the detection signal. That is, the detection signal output is reset.

As is apparent from a comparison between the existing ignition detection circuit 15 shown in FIG. 17 and the ignition detection circuit 23 of the present embodiment shown in FIG. 15, the number of components and the circuit scale are larger in the existing circuit. Specifically, the ignition detection circuit 23 of the present embodiment does not need to include the circuit for latching a detection output and the circuit for resetting the latched output, and thus achieves significant reduction in the number of components and circuit scale.

It should be noted that the present invention is not limited to the above-described configurations as the embodiment.

For example, a modification may be accordingly added to details of the specific circuit configuration of the ignition detection circuit 23 and details of the internal configuration and circuit configuration of the ballast power supply unit 11 including the ignition circuit 22.

Although a lighting-drive device and a light source device based on the present invention are applied to a rear-projection display device in the present embodiment, these devices may be applied also to other display devices. For example, these devices can be applied also to a light source device in a front-projection device. Furthermore, these devices can be applied also to a light source unit in a typical liquid crystal display panel, i.e., a so-called backlight unit.

The discharge lamp such as an HID lamp can be used not only as a light source of a display device but also as a light source of e.g. an illuminator, and embodiments of the invention can be applied as a circuit or device for driving the light source of the illuminator. The kind of lamp is not limited to an HID lamp. Any kind is available as long as the lighting thereof can be started by applying thereto a pulse (AC) with a voltage value higher than a certain value.

It should be understood by those skilled in the art that various modifications, combinations, sub-combinations and alterations may occur depending on design requirements and other factors insofar as they are within the scope of the appended claims or the equivalents thereof.

What is claimed is:

1. A lighting-drive device comprising:
a lighting-drive circuit configured to drive a lamp for lighting of the lamp;
an activation circuit configured to produce an activation voltage to be applied to the lamp in order to start lighting of the lamp; and
an activation operation detector configured to be provided with a sensing member for sensing an induced voltage arising due to an activation current and output an operation state notification signal depending on a state of the induced voltage sensed by the sensing member, the sensing member being provided on a circuit substrate on which the activation circuit is formed in such a manner as to be allowed to sense the induced voltage, the activation current flowing in response to the activation voltage produced by the activation circuit, the operation state notification signal indicating whether or not the activation circuit has operated normally, wherein
the lighting-drive circuit, the activation circuit and the activation operation detector are integrated into one single component.

2. The lighting-drive device according to claim 1, wherein
for the activation operation detector, the sensing member as an antenna line is disposed near a wiring pattern that is formed on the circuit substrate and through which the activation current flows, in such a manner as to be allowed to sense the induced voltage.

3. The lighting-drive device according to claim 1, wherein
for the activation operation detector, the sensing member as a conductive lead is disposed near a wiring pattern that is formed on the circuit substrate and through which the activation current flows, in such a manner as to be fixedly attached to the circuit substrate and be allowed to sense the induced voltage.

4. The lighting-drive device according to claim 1, wherein
the sensing member as a conductive pattern formed on the circuit substrate is disposed near a wiring pattern that is formed on the circuit substrate and through which the activation current flows, in such a manner as to be allowed to sense the induced voltage.

5. The lighting-drive device according to claim 4, wherein
the sensing member as the conductive pattern is formed on the same substrate surface as a substrate surface on which the wiring pattern through which the activation current flows is formed.

6. The lighting-drive device according to claim 4, wherein
the sensing member as the conductive pattern is formed on a substrate surface different from a substrate surface on which the wiring pattern through which the activation current flows is formed, on the circuit substrate.

7. The lighting-drive device according to claim 1, further comprising:
a controller configured to be allowed to control start of operation of the activation circuit and execute predetermined processing by using the operation state notification signal captured in the controller, the controller being included in the single component.

8. A light source device comprising:
a lamp configured to serve as a light source;
a lighting-drive circuit configured to drive the lamp for lighting of the lamp;
an activation circuit configured to produce an activation voltage to be applied to the lamp in order to start lighting of the lamp; and
an activation operation detector configured to be provided with a sensing member for sensing an induced voltage arising due to an activation current and output an operation state notification signal depending on a state of the induced voltage sensed by the sensing member, the sensing member being provided on a circuit substrate on which the activation circuit is formed in such a manner as to be allowed to sense the induced voltage, the activation current flowing in response to the activation voltage produced by the activation circuit, the operation state notification signal indicating whether or not the activation circuit has operated normally, wherein
at least the lighting-drive circuit, the activation circuit, and the activation operation detector are integrated into one single component.

9. A display device comprising:
a lamp configured to serve as a light source;
a lighting-drive device configured to drive the lamp for lighting of the lamp; and
an image display unit configured to display an image by use of light emitted from the light source, wherein
the lighting-drive device includes
a lighting-drive circuit that drives the lamp for lighting of the lamp,
an activation circuit that produces an activation voltage to be applied to the lamp in order to start lighting of the lamp, and
an activation operation detector that is provided with a sensing member for sensing an induced voltage arising due to an activation current and outputs an operation state notification signal depending on a state of the induced voltage sensed by the sensing member, the sensing member being provided on a circuit substrate on which the activation circuit is formed in such a manner as to be allowed to sense the induced voltage, the activation current flowing in response to the activation voltage produced by the activation circuit, the operation state notification signal indicating whether or not the activation circuit has operated normally, and
at least the lighting-drive circuit, the activation circuit, and the activation operation detector are integrated into one single component.
